(19) United States
(12) Patent Application Publication
(10) Pub. No.: US 2012/0179885 A1
(43) Pub. Date: Jul. 12, 2012

(54) WRITE CONTROL SYSTEM

(76) Inventors: Gregory L. Wade, San Jose, CA (US); J. Mitchell Haile, Somerville, MA (US)

(21) Appl. No.: 13/296,750

(22) Filed: Nov. 15, 2011

Related U.S. Application Data
(60) Provisional application No. 61/414,562, filed on Nov. 17, 2010.

(51) Int. Cl. G06F 12/16

(52) U.S. Cl. 711/162; 711/E12.103

(57) ABSTRACT

Embodiments disclosed herein provide systems and methods for writing a plurality of data blocks to from a primary source volume to a primary target volume. In a particular embodiment, a method provides receiving an instruction to write a plurality of data blocks from a primary source volume to a primary target volume and identifying in the data blocks occurrences of allocated data blocks and unallocated data blocks. The method further provides writing the allocated data blocks to the primary target volume and preventing writing of at least a portion of the unallocated data blocks to the primary target volume.

### CROSS REFERENCE

This application claims the benefit of U.S. Provisional Application No. 61/414,562, filed Nov. 17, 2010, which is hereby incorporated by reference in its entirety.

### TECHNICAL BACKGROUND

In the field of computer hardware and software technology, a virtual machine is a software implementation of a machine (computer) that executes program instructions like a real machine. Virtual machine technology allows for the sharing of, between multiple virtual machines, the physical resources underlying the virtual machines.

In virtual machine environments, storage volumes within the virtual machines contain data items that need to be accessed. Unfortunately, accessing the underlying contents of a storage volume can be very resource intensive, reducing the performance of a virtual machine and other operations within a virtual machine environment. One particularly resource intensive type of data access includes data restoration in virtual machine environments.

For example, a backup version of a portion or all of the virtual machine is stored in a backup environment. The backup version may then be accessed to restore virtual machine. Many data management systems require writing each block of data that is found in the backup environment, regardless of whether the blocks of data found on the storage volume are live blocks or merely place holder blocks. When restoring large volumes of data, the write portion of the process can strain system performance and increase input/output loads on the system, which inhibits the efficient writing of data.

### Overview

Embodiments disclosed herein provide systems and methods for writing a plurality of data blocks to from a primary source volume to a primary target volume. In a particular embodiment, a method provides receiving an instruction to write a plurality of data blocks from a primary source volume to a primary target volume and identifying in the data blocks occurrences of allocated data blocks and unallocated data blocks. The method further provides writing the allocated data blocks to the primary target volume and preventing writing of at least a portion of the unallocated data blocks to the primary target volume.

In another embodiment, the primary target volume is a virtual machine disk file.

In another embodiment, the primary source volume comprises a backup environment.

In another embodiment, the primary source volume includes data associated with a virtual machine disk file.

In another embodiment, the method further comprises transferring data associated with the allocated data blocks to a secondary data volume.

In another embodiment, the secondary data volume resides in a virtual machine environment.

In another embodiment, the secondary data volume comprises a virtual drive.

In another embodiment, receiving an instruction to write the primary source volume to the primary target volume includes receiving an instruction to perform a process including at least one of restoring, migrating, or backing up a virtual machine disk file.

In another embodiment, identifying occurrences of allocated data blocks and unallocated data blocks includes analyzing at least one source block bitmap.

In another embodiment, the method further comprises generating a target block bitmap of the allocated blocks.

In another embodiment, the method further comprises transferring the outgoing bitmap to the primary target volume.

In another embodiment, the outgoing bitmap is written to the primary target volume.

In yet another embodiment, a data allocation system for writing data comprises a primary source volume, the primary source volume including a plurality of data blocks, a primary target volume, and a write control system in communication with the primary source volume and the primary target volume. The write control system is configured to receive an instruction to write at least a portion of the primary source volume to the primary target volume and determine if each block is allocated or unallocated. The write control system is further configured to, if the data block is allocated to then write the data block to the primary target volume for writing the data block to the primary target volume, and if the data block is unallocated, then preventing writing of the unallocated block to the primary target volume.

In another embodiment, the primary source volume is a virtual machine disk file.

In another embodiment, the primary target volume is a virtual machine disk file.

In another embodiment, the write control system is further configured to transfer the allocated blocks from the primary target volume to a secondary data volume.

In another embodiment, the secondary data volume comprises a virtual drive.

In another embodiment, the write control system is configured to analyze at least one source block bitmap to determine if the blocks are allocated or unallocated.

In yet another embodiment, computer readable medium having program instructions stored thereon that, when executed by a data allocation system for writing at least a portion of a primary source volume to a primary target volume, instructs the data collection system to write the primary source volume to the primary target volume, wherein the primary source volume comprises a plurality of data blocks. Program instructions further instruct the data collection system to identify occurrences of allocated data blocks and unallocated data blocks in the primary source volume and write the allocated data blocks to the primary target volume and prevent writing of the unallocated data blocks to the primary target volume.

In another embodiment, the computer readable medium further comprises instructions to transfer data associated with the allocated blocks from the primary target volume to a secondary data volume.

### BRIEF DESCRIPTION OF THE DRAWINGS

FIG. 1 illustrates a data allocation system.

FIG. 2 illustrates the operation of a write control system.

FIG. 3 illustrates a write control system.

FIG. 4 illustrates a data allocation system.

FIG. 5 illustrates a data allocation system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

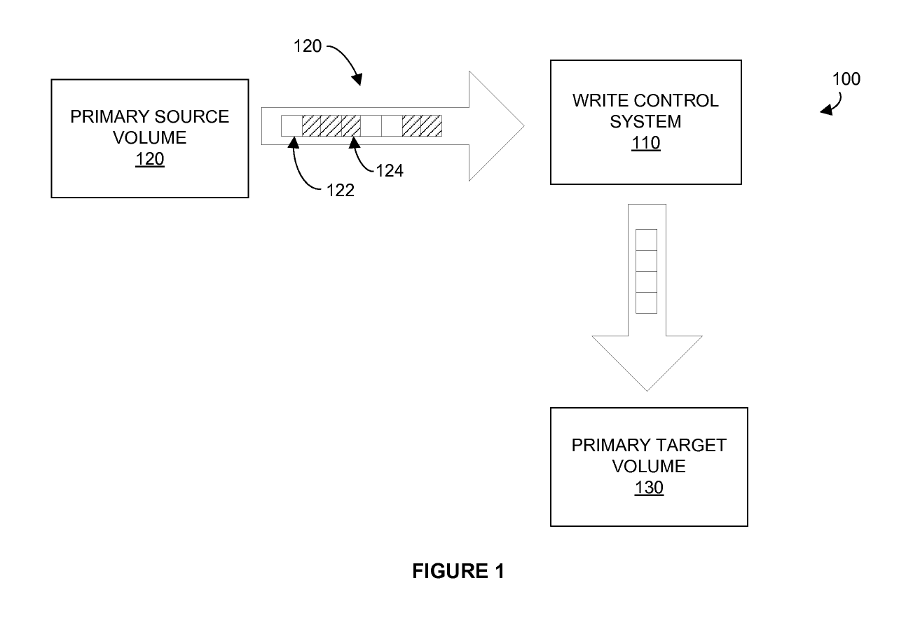

FIG. 1 is a schematic diagram illustrating operation of a data allocation system 100. As illustrated in FIG. 1, the data allocation system 100 includes a write control system 110 that is configured to transfer a primary source volume 120 to a primary target volume 130. In at least one example, the primary source volume 120 may be part of a backup environment to which a backup version of selected data has been transferred. It will be appreciated that the primary source volume 120 may be another data environment as desired.

As shown in FIG. 1, the data transferred from the primary source volume 120 includes allocated data blocks 122 (white blocks) and unallocated data blocks 124 (lined blocks). As will be described in more detail below, the write control system 110 analyzes the primary source volume 120 to identify occurrences of both the allocated data blocks 122 and unallocated data blocks 124.

The write control system 110 then transfers only the allocated data blocks 122 to a primary target volume 130. The primary target volume 130 may then write the allocated data blocks 122, as will be discussed in more detail at an appropriate point hereinafter. Such a configuration may allow the data allocation system 100 to operate more efficiently since writing of the unallocated blocks 124 is omitted.

In at least one example the data that write control system 110 transfers to the primary target volume 130 may be data that is flowing back into a virtual machine environment from a backup environment, such as when a backup version of the data is being restored to a live site or when a virtual machine disk file is being copied into a virtual machine environment. Such examples will be discussed in more detail at appropriate points hereinafter.

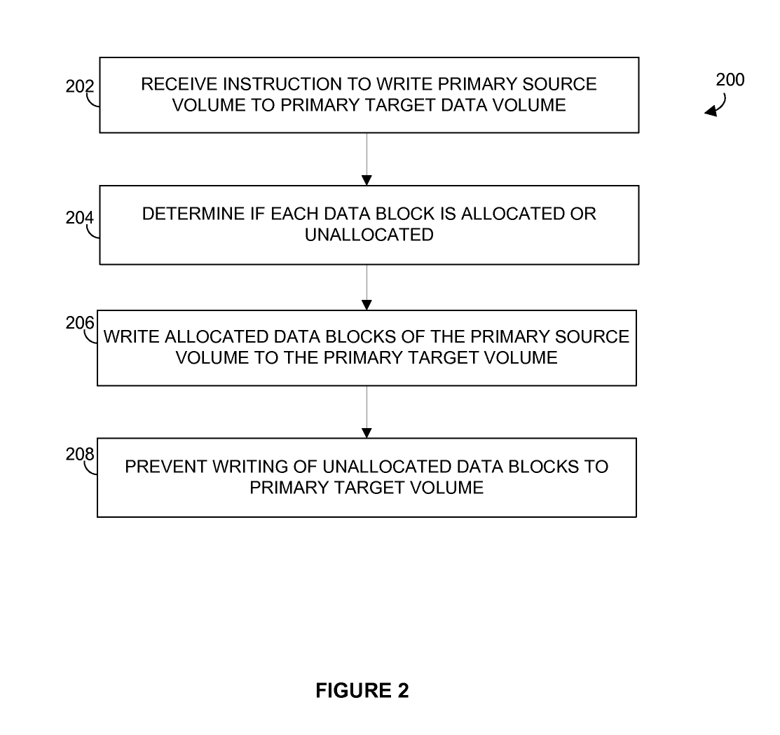

FIG. 2 is a flowchart of a process 200 that illustrates the operation of the write control system 110. Accordingly, FIGS. 1 and 2 will be referenced simultaneously in describing the process 200. As shown in FIGS. 1 and 2, the process begins when the write control system 110 receives an instruction to write at least a portion of the primary source volume 120.

In at least one example, the primary source volume 120 may be streamed to the primary target volume 130 (Step 202). For example, the data on the primary source volume 120 may comprise blocks of data that are streamed from a backup environment associated with the primary source volume 120 back into a Virtual Machine Disk (VMDK) file associated with the primary target volume 130. Consequently, the primary source volume 120 may also be a VMDK file in some examples.

Accordingly, streaming data from the primary source volume 120 to the primary target volume 130 may be part of a process in which data is restored to a live site, copied into a virtual machine environment, migrated from one virtual machine to another virtual machine, etc. It will be appreciated that the transfers described herein may also be part of other processes as well.

In response to the instruction described at step 202, the write control system 110 determines if each data block is an allocated data block 122 or an unallocated data block 124 (Step 204). The allocated data blocks 122 may correspond to data that is to be accessible by the user while the unallocated blocks 124 represent data that likely will not be accessed by users, such as data that acts as a place holder for indexing purposes. In particular, the data blocks 122 may correspond to data items to be transferred to a secondary data volume. In at least one example, a secondary data volume may reside on a virtual machine, as will be discussed at an appropriate point hereinafter.

Once the write control system 110 has identified the allocated data blocks 120, the write control system 110 then writes the allocated blocks 122 to the primary target volume 130 (Step 206) and prevents writing of the unallocated blocks 124 to the primary target volume 130 (Step 208).

Advantageously, process 200 provides for efficient writing of the primary source volume 120 to the primary target volume 130. In particular, only the data blocks that are actually to be accessed at a later time are written to the primary target volume 130. In contrast, data blocks that are not to be accessed at a later time are not written to the primary target volume 130.

Referring back to FIG. 1, the primary target volume 120 is any device or system capable of storing a volume of data and communicating with write control system 110. Primary source volume 120 may be, for example, a computer, a server computer, a disk array, a virtual machine running on a computer, or some other type of storage system, including any combination or variation thereof.

More specifically, the primary source volume 120 may include a virtual machine disk (VMDK) file. The primary target volume 130 may include a storage volume configured to store a VMDK file, such as a VMDK file residing on an underlying storage volume. In at least one example, the primary source volume 120 and/or the primary target file may be files residing on a physical, underlying disk volume or may be a virtual file residing on a virtual machine.

Accordingly, the primary source volume 120 and/or the primary target volume 130 may each be any device or system capable of storing a volume of data and communicating with the write control system 110. Primary source volume 120 and/or primary target volume 130 may thus be, for example, a computer, a server computer, a disk array, a virtual machine running on a computer, or some other type of storage system, including any combination or variation thereof.

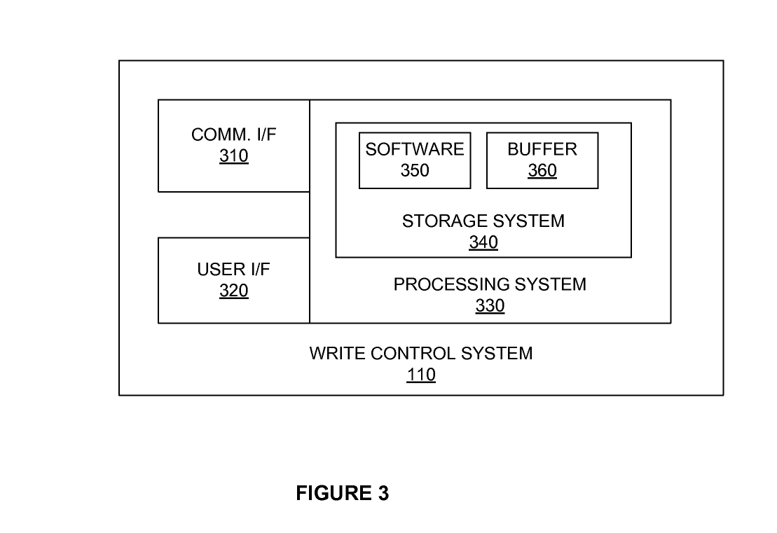

Write control system 110 may be any device or system capable of receiving storage instructions to transfer data between storage volumes. Accordingly, the write control system 110 may thus be, for example, a computer, a server computer, a disk array, a virtual machine running on a computer, or some other type of storage system, including any combination or variation thereof. In the example illustrated in FIG. 3, the write control system 110 includes a communication interface 310, a user interface 320, a processing system 330, storage system 340, software 350, and a buffer 360.

The processing system 330 is linked to the communication interface 310 and the user interface 320. The processing system 330 includes processing circuitry and the storage system 340 that stores software 350 and buffer 360. Write control system 110 may include other well-known components such as a power system and enclosure that are not shown for clarity.

In at least one example, the communication interface 310 comprises a network card, network interface, port, or interface circuitry that allows write control system 110 to communication with the various storage volumes, including the primary source and primary target volumes 120, 130 (FIG. 1). The communication interface 310 may also include a memory device, software, processing circuitry, or other communication devices as desired. The communication interface 310 may use various protocols, such as host bus adapters (HBA), SCSI, SATA, Fibre Channel, iSCSI, WiFi, Ethernet, TCP/IP, or the like to communicate with a plurality of storage volumes, including the primary source and primary target volumes 120, 130.

The user interface 320 comprises components that interact with a user to receive user inputs and to present media and/or information. The user interface 320 may include a speaker, microphone, buttons, lights, display screen, mouse, keyboard, or some other user input/output apparatus—including combinations thereof. The user interface 320 may be omitted in some examples.

In at least one example, the processing system 330 may include a microprocessor and other circuitry that retrieves and executes the software 350 from the storage system 340. The storage system 340 may include a disk drive, flash drive, data storage circuitry, or some other memory apparatus. The processing system 330 is typically mounted on a circuit board that may also hold the storage system 340 and portions of the communication interface 310 and the user interface 320.

The software 350 comprises computer programs, firmware, or some other form of machine-readable processing instructions. The software 350 may include an operating system, utilities, drivers, network interfaces, applications, or some other type of software. When executed by the processing system 330, the software 350 directs the processing system 330 to operate the write control system 110 as described herein.

In operation, the processing system 330 receives a command or instruction to write data streamed to the write control system 110 and intended to be transferred from the primary source volume 120 to the primary target volume 130 (both seen in FIG. 1). The instruction may originate from a remote computer system external to the write control system 110. However, it should be understood that the command may also originate from software executed by processing system 330, such as an application or operating system process running on the write control system 110.

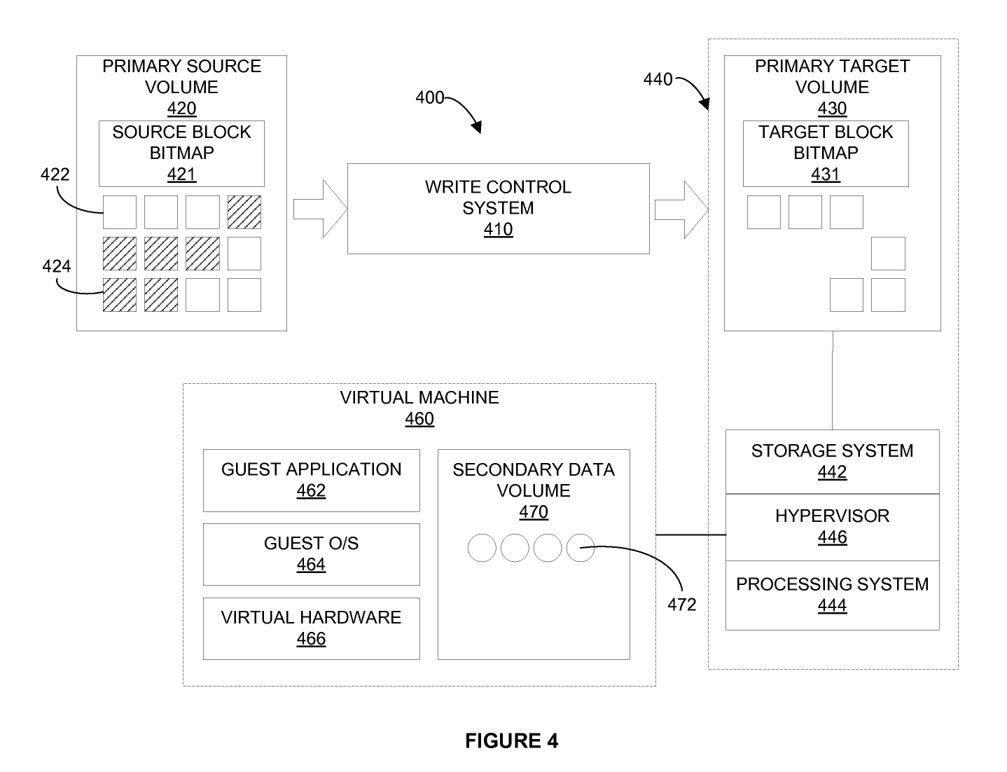

As discussed above, the primary source volume 120 (FIG. 1) comprises data blocks. Processing system 330 determines if the data blocks are allocated or unallocated and transfers only the allocated data blocks. If the data blocks are allocated, the processing system 330 functions with communication interface 310 write the block to the primary target volume 130 (FIG. 1). One example of such an operation is shown in more detail in FIG. 4.

FIG. 4 illustrates operation of a data storage system 400 in more detail. As illustrated in FIG. 4, the data storage system 400 generally includes write control system 410, a primary source volume 420, and a primary target volume 430. The primary source volume 420 includes a source block bitmap 421 that maps the location of allocated data blocks 422 and unallocated data blocks 424.

The write control system 410 analyzes the primary source volume 420 and/or data streamed to the primary target volume 430 to identify the allocated data blocks 422 and the unallocated data blocks 424. In at least one example, the write control system 421 may interrogate the source block bitmap 421 to identify the allocated data blocks 422 and the unallocated data blocks 424. The write control system 410 then writes only the allocated data blocks 422 to the primary target volume 430.

In FIG. 4, the allocated data blocks 422 are shown in the same relative positions in both the primary source volume 420 and the primary target volume 430 to emphasize that the same allocated data blocks 422 are written to primary target volume 430. It will be appreciated that the allocated data blocks 422 may be written to the primary target volume 430 in any desired manner.

In at least one example, the write control system 410 generates and writes a target block bitmap 431 to the primary target volume 430. The target block bitmap 431 may be the same as the source block bitmap 421 or may be different.

The primary target volume 430 may be associated with a computing device 440. For example, the primary target volume 430 may be a file, such as a VMDK file, that resides on a storage system 442. The computing device 440 may also include a processing system 444, and a hypervisor 446. The hypervisor 446 may be stored on the storage system 442 or other location as desired. The processing system 444 executes software associated with the hypervisor to a virtual machine 460.

The virtual machine 460 includes guest application(s) 462, a guest operating system 464, virtual hardware 466, and a secondary data volume 470. The guest operating system 464, the virtual hardware 466, and the secondary data volume 470 cooperate to provide a virtual machine environment, as is known in the art.

In the illustrated example, the secondary data volume 470 includes data items 472 stored thereon. The data items 472 may be data that the write control system 410 causes to be transferred from the primary target volume 430 to the secondary data volume 470. In at least one example, the secondary data volume 470 may comprise a virtual drive of the virtual machine 460.

Further, the allocated blocks 422 may correspond to the data used by the hypervisor 460 to generate other aspects of the virtual machine, such as the guest applications, the guest operating system, the virtual hardware, or even the entire virtual machine 460. Accordingly, transferring data from the primary source volume 420 to the primary target volume 430 may be part of a process in which the write control system 410 restores or migrates data to a primary target volume. The write control system 410 then causes the data to be transferred from the primary target volume to a live site, copied into a virtual machine environment, migrated from one virtual machine to another virtual machine, etc. It will be appreciated that the transfers described herein may also be part of other processes as well.

As discussed, the write control system 410 writes only the allocated data blocks 422 to the primary target volume 430 while preventing the writing of the unallocated blocks 424 to the primary target volume 430. By writing only the allocated blocks and preventing writing of the unallocated blocks, the write control system 410 may optimize the use of computing resources, especially since only the data items 472 associated with the allocated blocks 422 are then transferred from the primary target volume 430 to the secondary data volume 470.

While shown as an independent system, it should be understood that the functionality of write control system 410 could be integrated into primary source volume 420, primary target volume 430, or into some other element of computing device 440. For example, primary source volume 420 may be a data backup system product that uses hard drives, tape drives, flash memory, or some other type of data storage medium to back up various types of data. The functionality of write control system 410 may be integrated into the hardware or software of the data backup system as part of a single product. Similarly, in another example, computing device 440 may be a computer workstation, computer server, or a collection of computer servers that act as the physical machines on which one or more virtual machines execute. Computing device 440 may therefore include write control system 410 as a dedicated piece of hardware or an item of software installed on computer device 440.

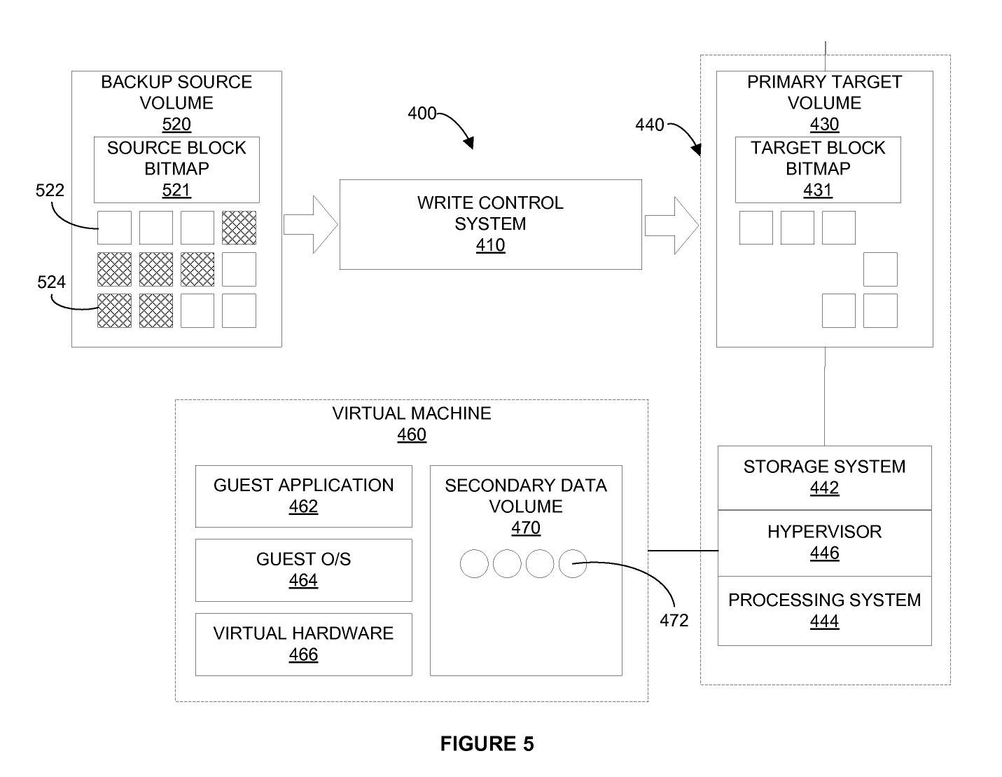

FIG. 5 illustrates a specific example in which the write control system 410 is transferring data from an exemplary backup environment. In the example illustrated in FIG. 5, the write control module 410 is configured to transfer data from a backup source volume 520 to the primary target volume 430. The backup source volume 520 may include some portion, or even all, of the data associated with a virtual machine.

As illustrated in FIG. 5, the backup source volume 520 includes a backup block bitmap 521 that identifies allocated data blocks 522 and unallocated data that has been replaced in the backup environment with synthetic blocks 524. Accordingly, the synthetic data blocks 524 may represent unallocated data blocks that were present on an underlying storage volume from which the backup source volume was read. The synthetic data blocks 524 may have been transferred to the backup environment as part of a process in which a data control system read only the allocated data blocks.

As part of a process for reading the backup source volume 520 from an underlying storage volume, the data control system 400 may have read the allocated data blocks 520 and generated the synthetic data blocks 524 rather than reading the unallocated data blocks from the underlying storage volume.

As shown in FIG. 5, the write control system 410 is configured to analyze the source block bitmap 512 to transfer the allocated data blocks 522 to the primary target volume 430 and prevent the transfer of the synthetic data blocks 524 to the primary target volume 430. Accordingly, the write control system 410 may optimize resource usage for a backup process in which data is flowing back into a virtual machine environment by writing only the allocated blocks and preventing writing of the synthetic and/or unallocated blocks.

It should be understood that the processes described herein are applicable to any type of volume, such as a memory swap device, raw database volume, or file system.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of writing a plurality of data blocks to from a primary source volume to a primary target volume, the method comprising:
receiving an instruction to write a plurality of data blocks from a primary source volume to a primary target volume;
identifying in the data blocks occurrences of allocated data blocks and unallocated data blocks;
writing the allocated data blocks to the primary target volume; and
preventing writing of at least a portion of the unallocated data blocks to the primary target volume.

2. The method of claim 1, wherein the primary target volume is a virtual machine disk file.

3. The method of claim 1, wherein the primary source volume comprises a backup environment.

4. The method of claim 1, wherein the primary source volume includes data associated with a virtual machine disk file.

5. The method of claim 1, further comprising transferring data associated with the allocated data blocks to a secondary data volume.

6. The method of claim 5, wherein the secondary data volume resides in a virtual machine environment.

7. The method of claim 6, wherein the secondary data volume comprises a virtual drive.

8. The method of claim 1, wherein receiving an instruction to write the primary source volume to the primary target volume includes receiving an instruction to perform a process including at least one of restoring, migrating, or backing up a virtual machine disk file.

9. The method of claim 1, wherein identifying occurrences of allocated data blocks and unallocated data blocks includes analyzing at least one source block bitmap.

10. The method of claim 9, further comprising generating a target block bitmap of the allocated blocks.

11. The method of claim 10, further comprising transferring the outgoing bitmap to the primary target volume.

12. The method of claim 11, wherein the outgoing bitmap is written to the primary target volume.

13. A data allocation system for writing data;
a primary source volume, the primary source volume including a plurality of data blocks;
a primary target volume; and
a write control system in communication with the primary source volume and the primary target volume, the write control system being configured to receive an instruction to write at least a portion of the primary source volume to the primary target volume, the write control system being further configured to determine if each block is allocated or unallocated, if the data block is allocated to then write the data block to the primary target volume for writing the data block to the primary target volume, and if the data block is unallocated, then preventing writing of the unallocated block to the primary target volume.

14. The data allocation system of claim 13, wherein the primary source volume is a virtual machine disk file.

15. The data allocation system of claim 14, wherein the primary target volume is a virtual machine disk file.

16. The data allocation system of claim 13, wherein the write control system is further configured to transfer the allocated blocks from the primary target volume to a secondary data volume.

17. The data allocation system of claim 16, wherein the secondary data volume comprises a virtual drive.

18. The data allocation system of claim 13, wherein the write control system is configured to analyze at least one source block bitmap to determine if the blocks are allocated or unallocated.

19. A computer readable medium having program instructions stored thereon that, when executed by a data allocation system for writing at least a portion of a primary source volume to a primary target volume, instructs the data collection system to:
write the primary source volume to the primary target volume, wherein the primary source volume comprises a plurality of data blocks;
identify occurrences of allocated data blocks and unallocated data blocks in the primary source volume; and
write the allocated data blocks to the primary target volume and prevent writing of the unallocated data blocks to the primary target volume.

20. The computer readable medium of claim 19, further comprising instructions to transfer data associated with the allocated blocks from the primary target volume to a secondary data volume.
